(19) United States
(12) Patent Application Publication
(10) Pub. No.: US 2016/0170382 A1
(43) Pub. Date: Jun. 16, 2016

(54) Time Synchronization Control Apparatus And Method

(71) Applicant: The Secretary Of State For Business, Innovation & Skills, London (GB)

(72) Inventor: Leon Lobo, London (GB)

(21) Appl. No.: 14/960,260

(22) Filed: Dec. 4, 2015

Related U.S. Application Data
(63) Continuation of application No. PCT/GB2014/051761, filed on Jun. 6, 2014.

(30) Foreign Application Priority Data
Jun. 6, 2013 (GB) 1310114.2

(51) Int. Cl. G04R 20/02

(52) U.S. Cl. CPC G04R 20/02

(57) ABSTRACT

A local clock network can have a reference control unit with a reference clock. Coupled to each reference clock can be a plurality of remote stations. User units are in the form of clock indicator units which provided clock signals for use by internal client systems. The network(s) is/are closed loop system(s) between the associated reference and remote user stations. Each reference station determines the latency associated with each remote user station and generates an offset for each user station. Each reference station then generates a specific clock signal for each remote user station on the basis of its reference clock signal adjusted by the appropriate user station offset. A plurality of separate networks can be synchronized by reference to their local Coordinated Universal Time clocks, with one reference station acting as a master station.

### CROSS-REFERENCE TO RELATED APPLICATIONS

This application is a continuation of International Application No. PCT/GB2014/051761 having a filing date of Jun. 6, 2014, entitled “Time Synchronisation Control Apparatus and Method”, which is related to and claims priority benefits from UK patent application No. GB1310114.2 filed on Jun. 6, 2013. This application also claims foreign priority benefits from the GB1310114.2 application. The '761 international application is hereby incorporated by reference herein in its entirety.

### FIELD OF THE INVENTION

The present invention relates to a system for and method of providing accurate and predictable synchronized clock signals at a plurality of remote stations.

### BACKGROUND OF THE INVENTION

There is an increasing need in many transactions and processes to be able to obtain an accurate indication of time, for example in control situations, for commercial and financial transactions, for measuring and monitoring and so on. For this purpose, there is an established central Coordinated Universal Time (UTC) reference which is administered by the BIPM, the International Bureau of Weights and Measures, in France. This reference is used by a plurality of metrology laboratories to provide a local Coordinated Universal Time (UTC) within their region. Where two separate entities wish to synchronize their transactions or work on a common clock, the Coordinated Universal Time from one UTC supplier is used as the time reference. Synchronization of physically separated and unconnected users is carried out using GPS, using GPS time as the single source for each user network. This is viable but is vulnerable to manmade and natural interferences such as jamming, spoofing, meaconing and solar storms. Additionally, the latencies introduced by each component of the receiver chain: antennae, cables, amplifiers, distribution systems, receivers and so on, require careful calibration in order to understand the traceability offsets that must be implemented.

Synchronization requirements on a global scale are becoming critical, particularly in sectors such as the financial trading sector. Audit trails and forensic analyses of events such as flash crashes are important to understand the causes of these events.

Errors in a local time clock caused by the above-mentioned latencies and vulnerabilities can result in the local time clocks of separated users being offset from one another often by as much as 1 millisecond and sometimes more. Errors in clock synchronization of this nature are becoming increasingly critical in many transactional environments.

### SUMMARY OF THE INVENTION

A system for providing a synchronized clock signal at a plurality of remote stations can include: a reference clock signal at a reference station, a clock signal indicator at each remote station, a two-way direct communication connection between the reference station and each remote station, a processing unit at the reference station, wherein the processing unit is operable to determine at least one latency in the clock signal indicator through each communication connection and to determine therefrom a remote station offset for each remote station, the processing unit being operable to store each remote station offset, and the reference station is operable to send to each remote station an individual clock signal based upon the reference clock and the associated station offset such that the clock signal indicators of most, if not all, the remote stations are synchronized.

Certain embodiments provide a system and apparatus able to provide accurate and predictable synchronized clock signals at a plurality of remote stations and which avoids many of the deficiencies of known systems.

The system in practice can provide a closed loop time synchronization environment in which the time indicator at each of a plurality of separate and remote stations is set and controlled by a reference station. In this manner, the reference station is able to aid, if not ensure, that the local time clocks of remote stations are synchronized, irrespective of their individual component of connection latencies. The system can also be robust in terms of communication between the reference station and the remote stations, utilizing in the preferred embodiment a direct cable link there between, thereby avoiding the vulnerabilities experienced with existing systems. It is not necessary for the remote stations to have involvement in the calculation of a synchronized time signal, itself liable to inaccuracies, as the control and provision of synchronized time signals is effected by the reference station. In practice, the reference station will determine for each remote station the latencies introduced by each component of the receiver chain: antennae, cables, amplifiers, distribution systems, receivers and so on, and generate from this a timing offset specific for that remote station.

In an embodiment, the two-way direct communication connection between the reference station and each remote station is a wired connection. Preferably, this connection is an optical fiber connection.

Advantageously, the processing unit of the reference station is operable to repeat at intervals the determination of the latency of each remote station and to adjust the remote station offsets on the basis of each determination.

In a preferred embodiment, the reference station is operable to determine a master offset in the reference clock signal on the basis of a master clock signal and to provide for adjustment of the reference time signal on the basis of the determined master offset. In a practical embodiment, the master clock signal is a local UTC, for example UTC (NPL) administered by the National Physical Laboratory in Teddington, England. Thus, the reference clock can be closely synchronized with UTC.

There can be a plurality of reference stations, each connected to its own set of remote stations, wherein the reference stations are operable to determine a reference time offset based on a difference between the reference times thereof, at least one of the reference stations being operable to adjust its reference time on the basis of the determined reference time offset. The system can therefore be spread to separate locations, with each location providing a network to local remote user stations which can be accurately synchronized. In practice, each reference station can be synchronized with a local UTC(x), thereby ensuring precise synchronization to Universal Time.

In some embodiments, there is a plurality of reference stations, each connected to its own set of remote stations, the plurality of reference stations including a master reference station and at least one slave reference station; wherein the reference stations are operable to determine a reference time offset for each slave reference station based on a difference between a reference clock signal thereof and a reference clock signal of the master reference station, each slave reference station being operable to adjust each remote station offset for its respective remote stations on the basis of the respective determined reference time offset.

In some embodiments, each slave reference station is operable to adjust each remote station offset for its respective remote stations on the basis of the respective determined reference time offset by adjusting its reference clock signal on the basis of the respective determined reference time offset.

A method of providing a synchronized clock signal at a plurality of remote stations, including the steps of: providing a reference clock signal at a reference station, providing a clock signal indicator at each remote station, providing a two-way direct communication connection between the reference station and each remote station, wherein the reference station determines at least one latency in the clock signal indicator through each communication connection and determines therefrom a remote station offset for each remote station, and the reference station sends to each remote station an individual clock signal based upon the reference clock and the associated station offset such that the clock signal indicators of the remote stations are synchronized.

Preferably, the two-way direct communication connection between the reference station and each remote station is a wired connection, most preferably an optical fiber connection.

In an embodiment, the reference station repeats at intervals the determination of the latency of each remote station and adjusts the remote station offsets on the basis of each determination.

In a preferred embodiment, the reference station determines a master offset in the reference clock signal on the basis of a master clock signal and provides for adjustment of the reference time signal on the basis of the determined master offset.

Advantageously, the method includes, for a plurality of reference stations, each connected to its own set of remote stations, the steps of determining a reference time offset based on a difference between the reference times of the plurality of reference stations, at least one of the reference stations adjusting its reference time on the basis of the determined reference time offset.

### BRIEF DESCRIPTION OF THE DRAWINGS

FIG. 1 is a schematic diagram of the existing clock synchronization arrangement for synchronizing separate user clocks.

FIG. 2 is a schematic diagram of a preferred embodiment of system for synchronizing separate user clocks.

FIG. 3 is a schematic diagram of the embodiment of system of FIG. 2 for synchronizing separate user clocks by means or separate Universal Time Clocks.

FIG. 4 is another schematic diagram of a system synchronizing separate user clocks.

### DESCRIPTION OF THE PREFERRED EMBODIMENTS

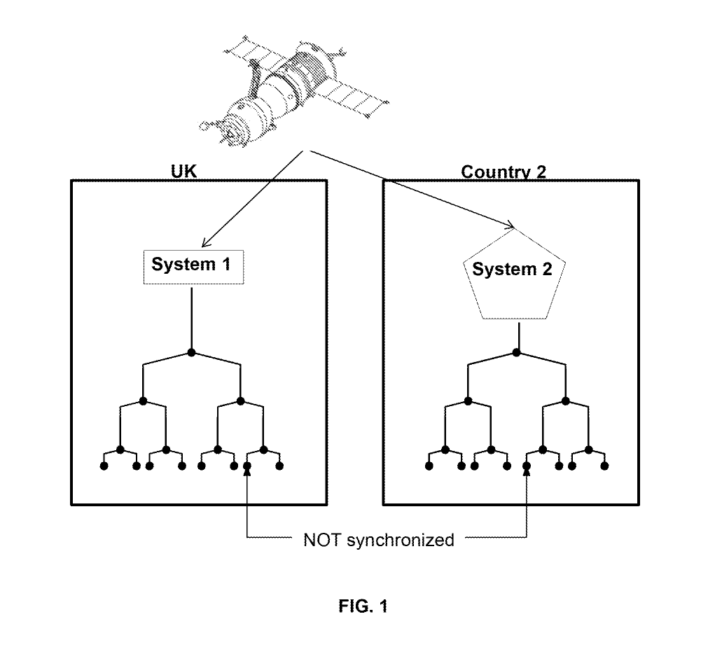

Referring first to FIG. 1, this shows in schematic form an example of the existing apparatus and arrangement for providing synchronized clock signals at separate locations.

A first system (system 1) provides a reference clock signal to a plurality of local users, shown as the nodes in the left-hand box in FIG. 1. Synchronization of physically separated and unconnected networks, for example in a second country, is carried out using GPS. In this case, the system uses GPS time as the single source for each network and the Universal Time Clock. This is viable but is vulnerable to manmade and natural interferences such as jamming, spoofing, meaconing and solar storms. Additionally, the latencies introduced by each component of the receiver chain, namely antennas, cables, amplifiers, distribution systems and receivers, require careful calibration in order to understand the traceability offsets that are implemented.

Synchronization requirements on a global scale are becoming critical, particularly in sectors such as the financial trading sector. Audit trails and forensic analyses of events such as flash crashes are important to understand the causes of these events. As a result, the system of FIG. 1 no longer provides sufficiently robust or sufficiently accurate time synchronization of clock signals at a plurality of separate locations.

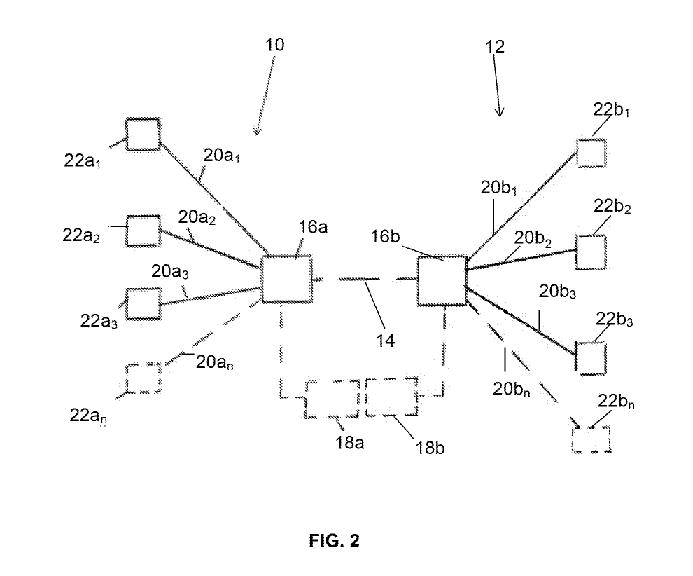

Referring to FIG. 2, there is shown a preferred embodiment of system for providing accurate and predictable synchronized clock signals at a plurality of remote stations. FIG. 2 shows two separated networks 10, 12, which are linked to one another by remote communications path 14, which can be a satellite link, a wire or other suitable path. It is to be understood that the system could include only one such network as it could include more than two networks.

Each network 10, 12 is provided with reference control unit 16a, 16b which includes a reference clock as well as a processing unit and a data memory. The reference clock can be synchronized to local Coordinated Universal Time (UTC) clock 18a, 18b, which itself is synchronized in accordance with the international protocol on UTC synchronization administered by the BIPM, the Bureau of Weights and Measures in France.

Coupled to each reference clock 16a, 16b by means of a two-way direct communication connection, preferably a cable and most preferably a fiber optic cable 20a₁-20aₙ and 20b₁-20bₙ, are a plurality of user remote stations units 22a₁-22aₙ and 22b₁-22bₙ. The user stations are typically clients desiring an accurate clock signal which is precisely and reliably synchronized with the local clock signal of other users within the network or interconnected networks. For instance, one set of user stations 22a can be branches of a bank and the other user stations 22b can be foreign branches of the same bank or of a different bank. The user station units 22a₁-22aₙ and 22b₁-22bₙ are preferably in the form of a clock indicator unit which provides a clock signal for use by the internal client systems. That local clock signal, as described below, is certified as accurately synchronized within a defined margin of error, which can, in some applications, be of the order of a few tens of nanoseconds and in others even more precise, by reference station 16 or by master reference station 16 in the case that a plurality of networks 10, 12 are operated together.

Each network 10, 12 is a closed loop system between associated reference station 16a, 16b and associated remote user stations 22a, 22b. Specifically, each reference station 16a, 16b has a processor associated therewith which is operable to determine the latency associated with each remote user station 22a₁-22aₙ and 22b₁-22bₙ, in practice the latencies introduced by each component of the receiver chain: antennas, cables, amplifiers, distribution systems, receivers and so on. Once determined the latency for each user station, reference station 16a, 16b determines an offset appropriate for each user station 22a₁-22aₙ and 22b₁-22bₙ in order to have each user station 22a₁-22aₙ and 22b₁-22bₙ indicate a time synchronized with the other user stations in network 10, 12. Those offsets are continuously re-evaluated and as appropriate stored in a memory associated with reference station 16a, 16b.

Each reference station 16a, 16b then generates a specific clock signal for each remote user station 22a₁-22aₙ and 22b₁-22bₙ on the basis of its reference clock signal adjusted by the appropriate user station offset. Individual user stations 22a₁-22aₙ and 22b₁-22bₙ are then supplied with their associated clock signal through communication lines 20a₁-20aₙ and 20b₁-20bₙ such that they indicate the same time in synchronous fashion. This synchronization can be extremely accurate given the control by reference station 16a, 16b. Moreover, client user stations 22a₁-22aₙ and 22b₁-22bₙ can be added at any time, with each new station having its latencies and associated offset determined by reference station 16a, 16b, thereby ensuring that the time indicator of the new client station is rapidly synchronized with the other client stations 22a₁-22aₙ and 22b₁-22bₙ of network 10, 12.

The distribution of specific clock signals for each remote user station can utilize public domain techniques of synchronization, such as IEEE 1588.

It is to be understood that each local Coordinated Universal Time Clock 18a, 18b can still transmit its clock signal in conventional manner for less critical clock synchronization, as occurs presently.

In the example shown in FIG. 2, each reference station 16a, 16b performs in the manner described above. In addition, the two reference clocks 16a and 16b are synchronized between one another. In this embodiment, each reference clock 16a and 16b is calibrated to its own Coordinated Universal Time Clock 18a, 18b, with the Coordinated Universal Time Clocks 18a, 18b calibrated in accordance with the BIPM. These calibrations are typically in the form of a calculated offset from the mean UTC derived from around four hundred local Universal Time Clocks run by various metrology laboratories and similar facilities.

The UTC formulation process is a monthly process whereby each UTC lab contributes its clock data to the BIPM in Paris. This data is used to form the weighted average timescale that is UTC. The offset UTC-UTC(k) of each lab's timescale from UTC, is disseminated via a newsletter called Circular T. The process of formulation and the publication effectively offers information of offsets one month in arrears. The offsets between labs could be several nanoseconds to hundreds of nanoseconds.

In the embodiment of FIG. 2, reference stations 16a and 16b repeatedly exchange time and frequency data via communications path 14, which can be a geo-stationary satellite link. Both reference stations transfer time and frequency data each way via communications path 14. This exchange is typically carried out at regular intervals considerably shorter than one month, such as daily or hourly. The implementation of two way satellite time and frequency transfers between reference stations, on an hourly basis, allows for rapid measurement of the offsets.

The offsets determined can be used by one of the reference stations 16a, 16b to ensure synchronization of their respective reference clocks. In practice, one of the reference stations 18a, 18b will be designated a master reference station to which other reference stations will calibrate. In other words, if in the example of FIG. 2 the reference station 16a is designated as master, the clock signal it will send to each associated user station 22a₁-22aₙ will be:

UTC (18a)±Offset (client 22aₙ)

On the other hand the clock signal sent by each associated or slave reference station will be:

UTC (18n)±Offset (UTC(18a to UTC18n)±Offset (client 22nₙ)

Thus, the clock signal for reference station 18b will be:

UTC (18b)±Offset (UTC(18a to UTC18b)±Offset (client 22bₙ)

It is not necessary for the communication link between reference stations 16a, 16b to be robust as they are able to rely on their local Coordinated Universal Time Clock and require only occasional calibration reference.

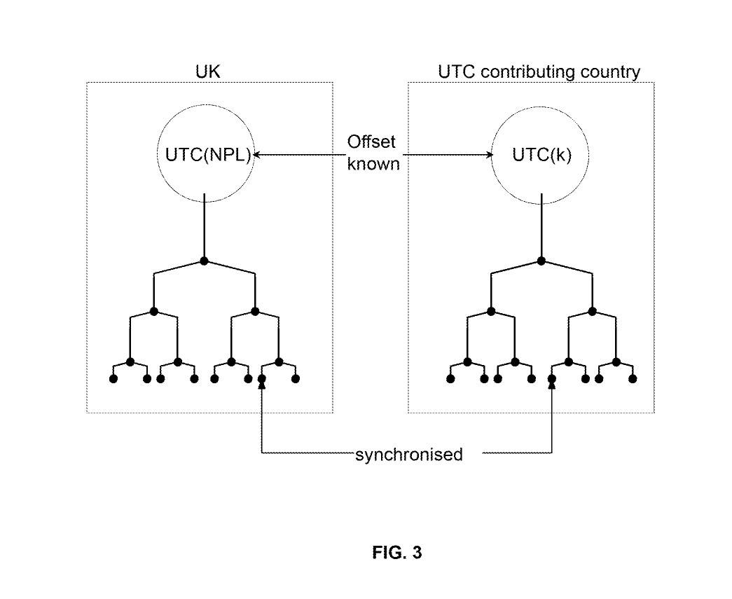

An example of this arrangement can be seen in FIG. 3.

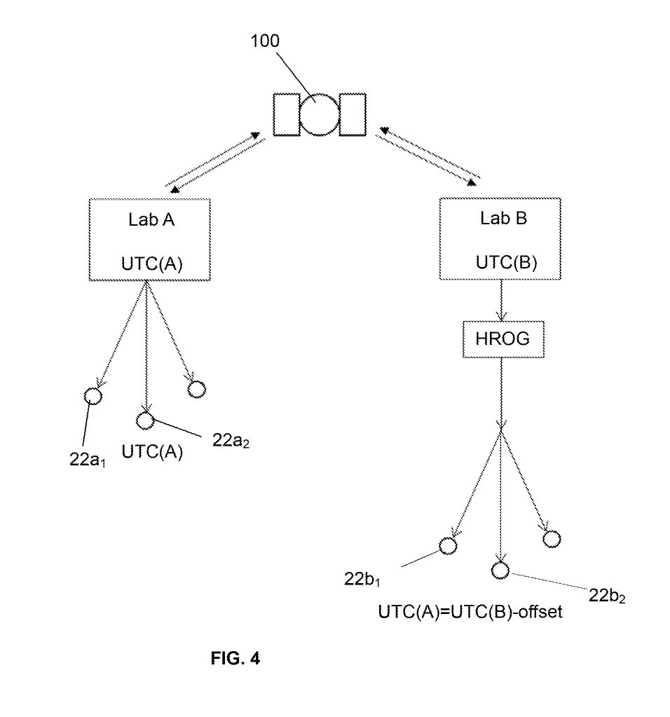

FIG. 4 shows another example of the system.

FIG. 4 shows reference stations, designated in this figure as Lab A and Lab B. Lab A is connected to a plurality of remote user stations 22a in a similar manner as described above, and Lab B is connected to a plurality of remote user stations 22b in a similar manner as described above. Lab A and Lab B are connected via a communications path as described above, in this case including geostationary satellite 100. Lab A includes a Coordinated Universal Time Clock providing a time signal UTC(A) and Lab B includes a Coordinated Universal Time Clock providing a time signal UTC(B).

If the timescale UTC(A), from lab A, is distributed to a network of users 22a, the replication of UTC(A) at lab B, via the transfer mechanism described above, allows for UTC(B), at lab B, to be distributed to a second network 22b, physically un-connected from that at lab A, via high resolution offset generators implementing the offset UTC(B)-UTC(A), thereby providing a large scale, un-connected, synchronized network.

It is to be noted that this differs from a physical point to point and bespoke synchronization methodology. Certain embodiments are able to scale as per the number of UTC labs in the consortium already submitting their data to the UTC formulation process via two time and frequency transfer.

In some embodiments, it is not necessary for reference stations 16a, 16b to have their own clock signal separate from Coordinated Universal Time Clocks 18a, 18b. In some embodiments, reference stations 16a, 16b can utilize time signals from the respective Coordinated Universal Time Clock, and calculate specific clock signals for remote user stations directly from the time signal from the respective Coordinated Universal Time Clock using the calculated offset described above without calculating an intermediate reference clock signal.

It is to be understood that in some embodiments it is not necessary for each reference clock 16a, 16b to transmit separate clock signals to each client station 22a₁-22aₙ and 22b₁-22bₙ. In another embodiment, each reference station 16a, 16b transmits the same reference clock signal which is then adjusted by the associated client offset, which can be stored either at reference station 16a, 16b or in associated client station 22a₁-22aₙ and 22b₁-22bₙ. It is preferred, though, that all control of the client clock signals is performed exclusively by associated reference station 16a, 16b to ensure reliability. This, moreover, can allow each reference station 16a, 16b and, in the case of a plurality of interconnected networks 10, 12, the master reference station, to certify the clock signal to a given synchronization accuracy.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

What is claimed is:

1. A system for providing a synchronized clock signal at a plurality of remote stations comprising:
a. a first reference station with a first reference clock signal;
b. a clock signal indicator at each of said first remote stations;
c. a two-way direct communication connections between said first reference station and each said first remote station; and
d. a processing unit at said first reference station configured to determine
i. a latency in said clock signal indicators through said communication connections; and
ii. a remote station offset for each said first remote station which said processing unit is configured to store,
wherein said first reference station is configured to send to said first remote stations an individual clock signal based upon said first reference clock signal and an associated station offset to synchronize said clock signal indicators.

2. The system according to claim 1 wherein said two-way direct communication connections are wired connections.

3. The system according to claim 2 wherein said wired connections are optical fiber connections.

4. The system according to claim 1 wherein said processing unit is configured to repeat at a given interval said determination of said latency of said remote stations and to adjust said remote station offsets on the basis of said determination.

5. The system according to claim 1 wherein said reference station is configured to
i. determine a master offset in said first reference clock signal on the basis of a master clock signal; and
ii. provide for adjustment of said first remote station offsets on the basis of said determined master offset.

6. The system according to claim 1 further comprising:
e. a second reference station with a second reference clock signal connected to a second plurality of remote stations, wherein said second reference stations is configured to determine a second reference time offset based on the difference between said second reference clock signals,
wherein at least one of said reference stations is configured to adjust each said remote station offset of its respective remote stations on the basis of said reference time offset.

7. The system according to claim 1 further comprising:
e. a second reference station, wherein said first reference station and said second reference station each includes
i. a master reference station with a master reference clock signal; and
ii. a slave reference station,
wherein each said reference station is connected to an individual set of remote stations and is configured to determine a reference time offset for each slave reference station based on the difference between said reference clock signal and said master reference clock signal; and
said slave reference stations are configured to adjust said remote station offsets for said remote stations based on said respective reference time offset.

8. The system according to claim 7 further comprising
f. a master-slave two-way communication connection between each said master reference station and each associated said slave reference station.

9. The system according to claim 8 wherein said master-slave two-way communication connection includes a satellite connection.

10. The system according to claim 7 wherein said master reference station is configured to exchange time and frequency data with each said slave reference station to determine said reference time offsets for said slave reference station.

11. The system according to claim 6 wherein said reference stations are configured to determine a reference time offset at hourly intervals.

12. A method of providing a synchronized clock signal at a plurality of remote stations comprises:
a. providing a reference clock signal at the reference station,
b. determining a latency in a clock signal indicator through a two-way direct communication connection via a reference station to a remote station offset for each said remote station; and
c. sending via said reference station an individual clock signal based upon said reference clock signal and said associated station offset to each remote station such that said clock signal indicators of said remote stations are synchronized.

13. The method according to claim 12 wherein said two-way direct communication connection is a wired connection.

14. The method according to claim 13 wherein said wired connection is an optical fiber connection.

15. The method according to claim 12 wherein determination of said latency repeats at intervals and said remote station offsets are adjusted based on said determinations.

16. The method according to claim 12 wherein said reference station
i. determines a master offset in said reference clock signal on the basis of a master clock signal; and
ii. provides for adjustment of each remote station offset on the basis of the determined master offset.

17. The method according to claim 12 further comprising:
d. determining a second reference time offset based on a difference between a second reference clock signals of a second reference station and a second set of remote stations
e. adjusting each remote station offset of said second set of remote stations on the basis of the determined second reference time offset.

18. The method according to claim 17 wherein each said reference stations include
i. a master reference station; and
ii. a slave reference station,
wherein said reference stations determine a reference time offset for said slave reference station based on a difference between a reference clock signal thereof and a reference clock signal of said master reference station, said slave reference station adjusting each remote station offset for its respective remote stations on the basis of said respective determined reference time offset.

19. The method according to claim 18, wherein said master reference station exchanges time and frequency data with said slave reference station in order to determine said reference time offsets for said at least one slave reference station.

20. The method according to claim 17, wherein said reference stations repeatedly determine a reference time offset at hourly intervals.
